(19) United States
(12) Patent Application Publication
(10) Pub. No.: US 2013/0059144 A1
(43) Pub. Date: Mar. 7, 2013

(54) CONCRETE SLEEPER AND METHOD FOR THE PRODUCTION THEREOF

(71) Applicant: Hermann Gärlich, Gerwisch (DE)

(72) Inventor: Hermann Gärlich, Gerwisch (DE)

(21) Appl. No.: 13/634,351

(22) PCT Filed: Mar. 11, 2011
(86) PCT No.: PCT/EP11/53709

§ 371 Date: Nov. 20, 2012

(30) Foreign Application Priority Data
Mar. 12, 2010 (EP) 10156347.6
Mar. 12, 2010 (EP) 10156352.6

(51) Int. Cl. E01B 3/46; B32B 13/02; B05D 1/12

(52) U.S. Cl. 428/293.4; 427/180

(57) ABSTRACT

The invention relates to a concrete sleeper comprising a plastic footing on its lower face and provided with a concrete body (12) which has a lower face (14). The concrete sleeper further comprises a plastic panel (18) which is disposed on the lower face (14) of the concrete body (12), the single-layer or multi-layer plastic panel (18) being connected to the concrete body (12) by a random fiber layer (16) which comprises fibers that are connected to the plastic panel (18) and/or are embedded in the concrete body (12). The random fiber layer (16) comprises fibers that have a diameter from 15 μm to 50 μm and a density from 20 to 200 fibers per square millimeter. Approximately 20% to 60% of the fibers have their free ends embedded in the concrete body (12) and the embedded fiber sections of the other fibers are designed as loops, approximately 10% to 60% of the free fiber ends embedded in the concrete being curved by 30° to 90° relative to the lower face (14) of the concrete body (12).

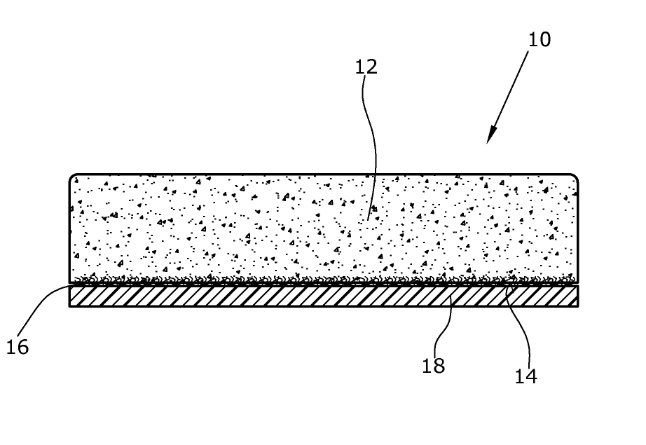

The invention relates to a concrete sleeper comprising a random fiber layer attached to its lower face, and a method for producing a concrete sleeper of this type.

In state-of-the-art composite systems wherein textile fiber structures and concrete are connected to each other, such as e.g. in the footing of sleepers made of concrete and respectively prestressed concrete, technical approaches are known which provide a force-locked connection of fibers to the concrete structures.

According to EP-B 1 298 252, for instance, elastic plastic layers are fixed to the lower face of sleepers by means of a random fiber layer in such a manner that a textile random fiber layer is bonded or welded in or on the plastic layer and, in the concrete, is attached by binding the fibers into the cement mortar or into a separately applied connecting material, e.g. an adhesive. As random fiber layers for connection between the sleepers, mentioned herein by way of example, and an elastic sleeper footing, use is made e.g. of geotextile and respectively nonwoven materials.

The majority of known nonwovens and also of other connecting media such as e.g. geotextile nonwoven materials have merely restricted properties for applications with force-locking where the functionality of a composite is desired to be unrestricted.

Plastic nettings with rigid fiber structures, for instance, are not capable to reposition the mineral structures in the fresh concrete with sufficient intensity to cause all connecting structures to be completely bound in the concrete. There will occur voids between the connecting medium and the concrete which e.g. will affect the elasticity behavior, in case of ingress of water will lead to pumping effects and will disturb the structural conditions in the concrete.

It is an object of the invention to provide a concrete sleeper comprising a plastic footing on its lower face, which concrete sleeper can be produced in a simple manner and whose plastic footing is mechanically attached to the concrete body of the concrete sleeper in a reliable manner, and to provide a method for producing such a concrete sleeper.

To achieve the above object, the invention proposes a concrete sleeper having a plastic footing on its lower face, said concrete sleeper comprising
a concrete body having a lower face, and
a plastic panel arranged on the lower face of the concrete body,
the single-layer or multi-layer plastic panel being connected to the concrete body by a random fiber layer which comprises fibers connected to the plastic panel and/or embedded in the concrete body.

In the above concrete sleeper, it is provided according to the invention
that the random fiber layer comprises fibers having a diameter from 15 μm to 50 μm and a density from 20 to 200 fibers per square millimeter, and
that approximately 20% to 60% of the fibers have their free ends embedded in the concrete body and that the embedded fiber sections of the other fibers are designed as loops,
approximately 10% to 60% of said free fiber ends embedded in the concrete being curved by 30° to 90° relative to the lower face of the concrete body.

In this concrete sleeper, it is provided according to the invention,
that the random fiber layer comprises fibers having a diameter from 15 μm to 50 μm and a density from 20 to 200 fibers per square millimeter, and
that approximately 20% to 60% of the fibers have their free ends embedded in the concrete body and that the embedded fiber sections of the other fibers are designed as loops,
approximately 10% to 60% of said free fiber ends embedded in the concrete being curved by 30° to 90° relative to the lower face of the concrete body.

According to the invention, the fibers have a substantially circular or elliptic cross section, the aspect ratio of the ellipse being not larger than 1:2.

According to a further advantageous embodiment of the invention, the fibers are affine to the components used for the concrete body when producing the latter.

It has become evident that known fibers and fiber-like random fiber materials such as, e.g., felt materials (produced by needling, finishing agents, fiber flow patterns and fiber shapes) are only to a limited extent suited, under the effect of the hydration suction occurring during the setting process of the concrete, to be autonomously bound by the fresh concrete in such a manner that the application conforming with the requirements will be guaranteed.

In the invention, when producing the concrete sleeper having a plastic footing on its lower face, the mechanical connection between these two elements is established by use of a random fiber layer comprising special fibers to the effect that, due to the hydration suction of the concrete during the setting of the latter, the fiber ends will enter capillary or gel pores of the concrete and, in the set state of the concrete, will be held therein. In the process, the random fiber layer can be connected, on its side facing away from the lower face of the concrete sleeper, to a single-layer or multi-layer plastic panel, notably prior to or after connection of the random fiber layer to the concrete sleeper.

According to the invention, there is further proposed a concrete sleeper which is produced according to the above method and preferably is provided with a plastic panel which is mechanically fixedly connected to the fiber layer and serves as a footing on the lower face.

Based on the recognition that, under defined composition and processing conditions, fresh concrete will develop hydration suction, the invention provides that the random fiber layer and the concrete are adjusted to each other in such a manner that the hydration suction will suck the connecting fiber structures into the fresh concrete.

For the technical use to be derived from this hydration suction, the following criteria from the fields of concrete technology, cement chemistry, textile technology, as well as the following application-specific criteria are defined as solutions in accordance with the invention.

Hydration as a reaction between water and cement will effect the generation of the cement stone. Some of the main components of the cement which are generated when the starting materials are burned and undergo a further modification in the klinker stage, will cause different reaction processes between the mixing water and exactly these cement components.

Particularly tricalcium aluminate and tricalcium silicate will result in a high reaction speed and will cause the development of the rigidity of the cement. The portion of calcium sulphate (gypsum) will influence and respectively delay the effect of the tricalcium aluminate. According to the invention, in the suitability test for the composition of the concrete, the method should be modified and respectively optimized by the selection of the cement type.

The fresh concrete, due to its high content of tricalcium aluminate and the cooperation of the latter with the properties of the other klinker components (substantially tricalcium silicate, dicalcium silicate and tetracalcium aluminate ferrite) of the fresh concrete which is not yet in its setting and hardening stage, will be given the ability to form fine fiber- and film-like calcium silicate hydrates and small crystals of calcium hydroxide.

Further, during the reaction of the aluminates with calcium sulphate, the calcium aluminate sulphate hydrates will be generated as needle-shaped tris-ulphates, the so-called ettringite.

The reaction of the tricalcium aluminate with the calcium sulphates will entail an increase of volume which in the not yet hardened concrete is without consequence in as far as no ettringite swelling will occur.

However, in the cement gel being in the generating stage and in the capillary and gel pores included therein, said increase of volume will bring about the so-called hydration suction.

As far as known, this hydration suction is not being used in any concrete-related technology as a process-technological advantage. Exclusively in the application of post-treatment materials in concrete-road construction, the use of similar effects is known.

According to the invention, said concrete-technological hydration suction is technically and economically used for a well-aimed binding of the fibers into the surface of the fresh concrete.

The gel pores, when constituting a portion of preferably about 25% of the gel volume and having a pore radius from 10⁻⁷ mm to 10⁻⁵ mm, are capable of sucking the fibers of a material laid onto the fresh concrete if these fibers have a concludent structure and nature relative to the capillary and gel pores. The capillary and gel pores normally have a cylindrical shape and, with increasing pore depth, taper toward so-called flange pores. The fibers suited for use of the hydration suction have to be concludent to the effect that, as provided according to the invention, they can penetrate both into the cylindrical and into the tapering parts of the pores. The capillary pores with pore radii particularly from 10⁻⁵ to 10⁻¹ mm cooperate with the gel pores with respect to the pore size nearly without technically disadvantageous transition.

In the case of the geotextiles used in the example of a sleeper footing, there is employed a random fiber structure of PE and respectively PET with fiber diameters of preferably about 20 μm to 40 μm. These fiber diameters and the provided fiber thickness of suitably 40 to 130 threads/mm² will offer the compatibility between hydration suction, capillary and gel pores, fiber diameter and fiber density which is required for the suctioning of the fibers.

As further preconditions for the effectiveness of the autonomous take-up of fibers of defined fiber thickness and fiber density as a result of hydration suction, there can be defined, according to the invention, the geometric shape of the fibers and their cross section as well as their orientation and affinity towards the mixing water and the cement gel. This applies e.g. to such geotextiles or other random fiber structures and respectively fiber materials which in their production process are made hydrophobic and/or, due to the nozzle discharge, have a cross section which is not in compliance with the geometry of the hydration pores, e.g. a rectangular cross section.

In this regard, the fibers available to be bound into the concrete should have free ends in a defined percentage of preferably 20% to 50%. Only a limited percentage of preferably less than 50% of the fibers should be formed as loops. The free ends of the fibers should not extend exclusively linearly; a percentage of e.g. 10% to 60% should be curved in such a manner that the angle of curvature is at least 30° but not larger than 90°.

The cross section of the fibers should be circular to elliptic, wherein the aspect ratio of the ellipse should not be larger than 1:2.

The fibers themselves should have been freed of residues from the fiber and netting production which have an affinity to cement paste, to the gel or to the mixing water. As materials for the fibers, known plastic fiber materials (e.g. thermoplastic materials such as PE or PET), metals (metal fibers) or also sustainable and respectively vegetable raw materials can be considered.

With reference to the drawing which shows a sectional view of a concrete sleeper having an elastic plastic panel mechanically attached to its lower face via a random fiber layer, an embodiment of the invention will be explained hereunder in greater detail.

The drawing shows, by way of example, a concrete sleeper 10 comprising a reinforced, loosely reinforced or non-reinforced concrete (solid) body 12 which on its lower face 14 is provided with a random fiber layer 16, partially embedded in the lower face, which by bonding or welding or in another manner is mechanically connected to a single-layer or multi-layer plastic panel 18. The distance between the lower face 14 of concrete body 12 and the plastic panel 18, which in the drawing is shown for clearer representation, does not necessarily have to exist.

In the lower-face elastic coatings—referred to as sleeper footings—of sleepers made of concrete and respectively pretensioned concrete, random fiber layers with defined fiber properties will be melted into the elastic coating materials.

These random fiber layers, after having been melted, on one side, by about half of the fiber length into the elastic materials, will comprise a portion of non-bound fibers projecting from the elastic materials for binding attachment to the concrete sleepers.

This portion of free fibers consists of fiber ends and fiber loops. The fiber loops, when laid onto the fresh concrete of a concrete sleeper in its production stages, will be enclosed by the cement paste and effect a basic strength of the attachment.

With this basic strength, it is possible to reach tearing strengths between the concrete and the elastic coating of about 0.3 N/mm ² to 0.5 N/mm². These values are in the limit range of the technical requirements of railroad companies and their guidelines.

The technical use of the hydration suction for a force-locking binding of free fiber ends in the fresh concrete will lead to tearing strengths above 1.5 N/mm², thus making it possible to guarantee the fulfillment of high quality demands of railroad companies and to reach an optimum system redundancy.

In fiber diameters of about 25 μm to about 40 μm and a fiber density from 40 to 130 fibers per mm² and with use of low-calcium-sulphate cements, the fiber ends will be sucked, by use of the hydration suction, into the ettringite which is presently being generated. The air existing in the ambience of the resulting matrix of fibers and cement paste and being under atmospheric pressure, is useful as a recipient only under certain conditions. A further technical connection exists to the hydration energy. Thus, it is also possible, under conditions of reduced air pressure (e.g. vacuum concrete), to apply elastic plastics to concrete sleepers according to this principle.

The invention has been explained above in the context of a concrete sleeper as an application for a concrete component. It is to be understood, however, that this does not restrict the invention to concrete sleepers but that the invention is applicable in all situations where the concrete body of a concrete component has to be mechanically connected to a plastic panel.

1. A concrete sleeper with a plastic footing on its lower face, comprising:
a concrete body having a lower face, and
a plastic panel arranged on the lower face of the concrete body,
the single-layer or multi-layer plastic panel being connected to the concrete body by a random fiber layer which comprises fibers connected to the plastic panel and/or embedded in the concrete body,
wherein
the random fiber layer comprises fibers having a diameter from 15 μm to 50 μm and a density from 20 to 200 fibers per square millimeter, and
approximately 20% to 60% of the fibers have their free ends embedded in the concrete body and the embedded fiber sections of the other fibers are designed as loops,
approximately 10% to 60% of said free fiber ends embedded in the concrete being curved by 30° to 90° relative to the lower face of the concrete body.

2. The concrete sleeper according to claim 1, characterized in that the fibers have a substantially circular or elliptic cross section, the aspect ratio of the ellipse being not larger than 1:2.

3. The concrete sleeper according to claim 1, characterized in that the fibers are affine to the components used for the concrete body when producing the latter.

4. A method for producing a concrete sleeper having attached to its lower face a random fiber layer comprising fibers,
wherein, due to the hydration suction of the concrete during the setting of the concrete, fiber ends are caused to enter capillary and/or gel pores of the concrete and are held therein in the set state of the concrete.

5. The method according to claim 4, wherein the random fiber layer, on its side facing away from the lower face of the concrete sleeper, is being connected to a single-layer or multi-layer plastic panel, notably prior to or after connection of the random fiber layer to the concrete sleeper.

6. A concrete sleeper, comprising a random fiber layer attached in accordance with claim 4.

7. A concrete sleeper according to claim 6, comprising a plastic panel attached to the random fiber layer wherein the random fiber layer, on its side facing away from the lower face of the concrete sleeper, is being connected to a single-layer or multi-layer plastic panel, notably prior to or after connection of the random fiber layer to the concrete sleeper.
